(19) United States
(12) Patent Application Publication
(10) Pub. No.: US 2024/0106322 A1
(43) Pub. Date: Mar. 28, 2024

(54) POWER CONVERSION SYSTEM AND CONTROL METHOD

(71) Applicant: Panasonic Holdings Corporation, Osaka (JP)

(72) Inventors: Hirokazu NAKAMURA, Osaka (JP); Kohei TSUKAMOTO, Osaka (JP); Kenichi ASANUMA, Osaka (JP); Ryoji MATSUI, Osaka (JP)

(21) Appl. No.: 18/263,502

(22) PCT Filed: Jan. 22, 2022
(86) PCT No.: PCT/JP2022/002198

§ 371 Date: Jul. 28, 2023

(30) Foreign Application Priority Data
Feb. 8, 2021 (JP) 2021-018537

(51) Int. Cl. H02M 1/32; H02M 3/335

(52) U.S. Cl. CPC H02M 1/32; H02M 3/33584

(57) ABSTRACT

In a power conversion system, a control circuit has, as its operation modes: a first control mode in which control circuit controls a DC-DC converter at a first drive frequency; a second control mode in which control circuit controls DC-DC converter at a second drive frequency higher than first drive frequency; and a third control mode in which control circuit controls DC-DC converter at a third drive frequency higher than first drive frequency. Control circuit is configured to change operation mode from first control mode into second control mode when detector circuit detects a predetermined change in output voltage while control circuit is operating in first control mode. Control circuit controls DC-DC converter in third control mode in a process of changing, in response to detection of predetermined change, operation mode from first control mode into second control mode before starting to control DC-DC converter in second control mode.

### TECHNICAL FIELD

The present disclosure generally relates to a power conversion system and a control method, and more particularly relates to a power conversion system including a DC-DC converter and a method for controlling the power conversion system.

### BACKGROUND ART

Patent Literature 1 discloses, as a DC-DC converter that may have an output voltage higher than a voltage corresponding to the turn ratio of a transformer, an insulated bidirectional DC-DC converter in which either a low-voltage switching section or a high-voltage switching section is connected to primary winding of an insulated transformer and the other switching section is connected to secondary winding of the insulated transformer.

In the insulated bidirectional DC-DC converter of Patent Literature 1, a current resonant capacitor is connected in series between the low-voltage switching section and the insulated transformer and another current resonant capacitor is connected between the high-voltage switching section and the insulated transformer.

In general, a power conversion system is sometimes required to have an output voltage variable within a broader range. Such a power conversion system allows, while a DC-DC converter is operating, a control circuit for the DC-DC converter to change the circuit topology of the DC-DC converter. Nevertheless, changing the circuit topology of the DC-DC converter could cause the DC-DC converter to generate an overcurrent.

### CITATION LIST

### Patent Literature

Patent Literature 1: JP 2016-63711 A

### SUMMARY OF INVENTION

It is therefore an object of the present disclosure to provide a power conversion system and a control method, both of which contribute to reducing the chances of generating an overcurrent.

A power conversion system according to an aspect of the present disclosure includes a DC-DC converter, a detector circuit, and a control circuit. The DC-DC converter includes a transformer, a first capacitor, and a second capacitor. The transformer includes a first winding and a second winding and has a first leakage inductance on the first winding and a second leakage inductance on the second winding. The first capacitor serves as a resonant capacitor and is connected to the first winding. The second capacitor also serves as a resonant capacitor and is connected to the second winding. The detector circuit detects a change in output voltage of the DC-DC converter. The control circuit controls the DC-DC converter. The control circuit has, as operation modes thereof: a first control mode in which the control circuit controls the DC-DC converter at a first drive frequency; a second control mode in which the control circuit controls the DC-DC converter at a second drive frequency higher than the first drive frequency; and a third control mode in which the control circuit controls the DC-DC converter at a third drive frequency higher than the first drive frequency and different from the second drive frequency. The control circuit is configured to change the operation mode from the first control mode into the second control mode when the detector circuit detects a predetermined change in the output voltage while the control circuit is operating in the first control mode. The control circuit controls the DC-DC converter in the third control mode in a process of changing, in response to detection of the predetermined change, the operation mode from the first control mode into the second control mode before starting to control the DC-DC converter in the second control mode.

A control method according to another aspect of the present disclosure is a method for controlling a power conversion system. The power conversion system includes a DC-DC converter and a detector circuit. The DC-DC converter includes a transformer, a first capacitor, and a second capacitor. The transformer includes a first winding and a second winding and has a first leakage inductance on the first winding and a second leakage inductance on the second winding. The first capacitor serves as a resonant capacitor and is connected to the first winding. The second capacitor serves as a resonant capacitor and is connected to the second winding. The detector circuit detects a change in output voltage of the DC-DC converter. The method includes controlling the DC-DC converter in a third control mode, in a process of changing, in response of detection of a predetermined change in the output voltage by the detector circuit, an operation mode from a first control mode into a second control mode before starting to control the DC-DC converter in the second control mode. The first control mode is an operation mode in which the DC-DC converter is controlled at a first drive frequency. The second control mode is an operation mode in which the DC-DC converter is controlled at a second drive frequency higher than the first drive frequency. The third control mode is an operation mode in which the DC-DC converter is controlled at a third drive frequency higher than the first drive frequency and different from the second drive frequency.

### BRIEF DESCRIPTION OF DRAWINGS

FIG. 1 is a circuit diagram of a power conversion system according to an exemplary embodiment;

FIG. 2 shows how the power conversion system operates;

FIG. 3 shows how the power conversion system operates;

FIG. 4 is an equivalent circuit diagram of a DC-DC converter for use in a situation where the power conversion system controls the DC-DC converter in a full-bridge control mode;

FIG. 5 is an equivalent circuit diagram of a DC-DC converter for use in a situation where the power conversion system controls the DC-DC converter in a voltage doubler control mode;

FIG. 6 is an equivalent circuit diagram of a DC-DC converter for use in a situation where the power conversion system controls the DC-DC converter in a half-bridge control mode;

FIG. 7 is a timing chart showing how the power conversion system controls the DC-DC converter in the full-bridge control mode;

FIG. 8 shows a current path in a situation where the power conversion system controls the DC-DC converter in the full-bridge control mode;

FIG. 9 shows a current path in the situation where the power conversion system controls the DC-DC converter in the full-bridge control mode;

FIG. 10 shows a current path in the situation where the power conversion system controls the DC-DC converter in the full-bridge control mode;

FIG. 11 shows a current path in the situation where the power conversion system controls the DC-DC converter in the full-bridge control mode;

FIG. 12 is a timing chart showing how the power conversion system controls the DC-DC converter in the voltage doubler control mode;

FIG. 13 shows a current path in a situation where the power conversion system controls the DC-DC converter in the voltage doubler control mode;

FIG. 14 shows a current path in the situation where the power conversion system controls the DC-DC converter in the voltage doubler control mode;

FIG. 15 shows a current path in the situation where the power conversion system controls the DC-DC converter in the voltage doubler control mode;

FIG. 16 shows a current path in the situation where the power conversion system controls the DC-DC converter in the voltage doubler control mode;

FIG. 17 shows a current path in a situation where the power conversion system controls the DC-DC converter in the half-bridge control mode;

FIG. 18 shows a current path in the situation where the power conversion system controls the DC-DC converter in the half-bridge control mode;

FIGS. 19A and 19B show how the power conversion system operates;

FIG. 20 shows how a power conversion system according to a first variation of the exemplary embodiment operates; and

FIG. 21 is an equivalent circuit diagram of a power conversion system according to a second variation of the exemplary embodiment.

### DESCRIPTION OF EMBODIMENTS

### Embodiment

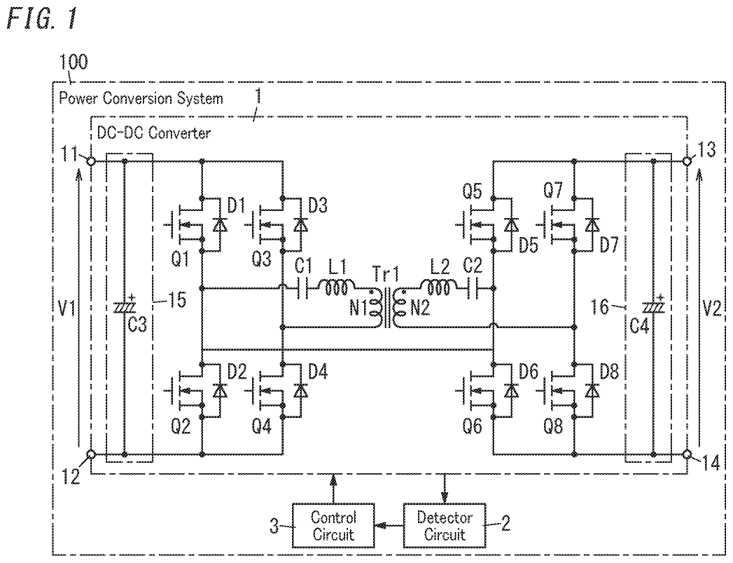

A power conversion system 100 according to an exemplary embodiment will be described with reference to FIGS. 1-18, 19A, and 19B.

(1) Overall Configuration for Power Conversion System

As shown in FIG. 1, the power conversion system 100 includes a DC-DC converter 1, a detector circuit 2, and a control circuit 3. The DC-DC converter 1 includes a transformer Tr1, a first capacitor C1, and a second capacitor C2. The transformer Tr1 includes a first winding N1 and a second winding N2 and has a first leakage inductance on the first winding N1 and a second leakage inductance on the second winding N2. FIG. 1 is an equivalent circuit diagram showing the first leakage inductance of the transformer Tr1 as a first inductor L1 serving as a resonant inductor and the second leakage inductance as a second inductor L2 serving as a resonant inductor. The first capacitor C1 serves as a resonant capacitor and is connected to the first winding N1. In the equivalent circuit diagram, the first capacitor C1 is connected to the first winding N1 via the first inductor L1. The second capacitor C2 serves as a resonant capacitor and is connected to the second winding N2. In the equivalent circuit diagram, the second capacitor C2 is connected to the second winding N2 in series via the second inductor L2. The detector circuit 2 detects a change in the output voltage of the DC-DC converter 1. The control circuit 3 controls the DC-DC converter 1. In the transformer Tr1, the number of turns of the second winding N2 is larger than the number of turns of the first winding N1. In the transformer Tr1, the turn ratio of the first winding N1 to the second winding N2 may be, but does not have to be, 1 to 2, for example.

The DC-DC converter 1 may be, for example, a bidirectional DC-DC converter with the ability to convert voltage bidirectionally between two pairs of input/output terminals, namely, between the first input/output terminal 11 and the second input/output terminal 12 and between the third input/output terminal 13 and the fourth input/output terminal 14. The DC-DC converter 1 is applicable to, for example, a power conditioner. In this embodiment, the DC-DC converter 1 may be applied to, for example, a power conditioner compliant with the CHAdeMO® specification.

(2) Details of Power Conversion System

As shown in FIG. 1, in the power conversion system 100, the DC-DC converter 1 is an insulated bidirectional DC-DC converter which uses the transformer Tr1. More specifically, the DC-DC converter 1 is a CLLC resonant bidirectional DC-DC converter that uses resonance produced between the first capacitor C1 and the first inductor L1 and resonance produced between the second inductor L2 and the second capacitor C2.

The DC-DC converter 1 includes a first input/output terminal 11, a second input/output terminal 12, a third input/output terminal 13, and a fourth input/output terminal 14.

Also, the DC-DC converter 1 is a switching DC-DC converter including a plurality of semiconductor switching elements (namely, first to eighth semiconductor switching elements Q1-Q8). In other words, the DC-DC converter 1 includes a series circuit of the first semiconductor switching element Q1 and the second semiconductor switching element Q2; a series circuit of the third semiconductor switching element Q3 and the fourth semiconductor switching element Q4; a series circuit of the fifth semiconductor switching element Q5 and the sixth semiconductor switching element Q6; and a series circuit of the seventh semiconductor switching element Q7 and the eighth semiconductor switching element Q8. The series circuit of the first and second semiconductor switching elements Q1, Q2 is connected between the first input/output terminal 11 and the second input/output terminal 12. The series circuit of the third and fourth semiconductor switching element Q3, Q4 is connected between the first input/output terminal 11 and the second input/output terminal 12. The series circuit of the fifth and sixth semiconductor switching element Q5, Q6 is connected between the third input/output terminal 13 and the fourth input/output terminal 14. The series circuit of the seventh and eighth semiconductor switching element Q7, Q8 is connected between the third input/output terminal 13 and the fourth input/output terminal 14.

The DC-DC converter 1 further includes a first diode D1, a second diode D2, a third diode D3, a fourth diode D4, a fifth diode D5, a sixth diode D6, a seventh diode D7, and an eighth diode D8. The first diode D1 is connected antiparallel to the first semiconductor switching element Q1. The second diode D2 is connected antiparallel to the second semiconductor switching element Q2. The third diode D3 is connected antiparallel to the third semiconductor switching element Q3. The fourth diode D4 is connected antiparallel to the fourth semiconductor switching element Q4. The fifth diode D5 is connected antiparallel to the fifth semiconductor switching element Q5. The sixth diode D6 is connected antiparallel to the sixth semiconductor switching element Q6. The seventh diode D7 is connected antiparallel to the seventh semiconductor switching element Q7. The eighth diode D8 is connected antiparallel to the eighth semiconductor switching element Q8.

In this DC-DC converter 1, each of the first to eighth semiconductor switching elements Q1-Q8 includes a control terminal, a first main terminal, and a second main terminal. The respective control terminals of the first to eighth semiconductor switching elements Q1-Q8 are connected to the control circuit 3. The first to eighth semiconductor switching elements Q1-Q8 are tuned ON and OFF in accordance with a control signal (control voltage) supplied from the control circuit 3. Each of the first to eighth semiconductor switching elements Q1-Q8 may be, for example, a metal-oxide semiconductor field effect transistor (MOSFET). More specifically, each of the first to eighth semiconductor switching elements Q1-Q8 is an n-channel MOSFET. In this embodiment, the n-channel MOSFET is a normally OFF Si-based MOSFET. In each of the first to eighth semiconductor switching elements Q1-Q8, the control terminal, the first main terminal, and the second main terminal thereof are a gate terminal, a drain terminal, and a source terminal, respectively.

In the DC-DC converter 1, the drain terminal of the first semiconductor switching element Q1 is connected to the first input/output terminal 11, the source terminal of the first semiconductor switching element Q1 is connected to the drain terminal of the second semiconductor switching element Q2, and the source terminal of the second semiconductor switching element Q2 is connected to the second input/output terminal 12.

In the DC-DC converter 1, the drain terminal of the third semiconductor switching element Q3 is connected to the first input/output terminal 11, the source terminal of the third semiconductor switching element Q3 is connected to the drain terminal of the fourth semiconductor switching element Q4, and the source terminal of the fourth semiconductor switching element Q4 is connected to the second input/output terminal 12.

In the DC-DC converter 1, the drain terminal of the fifth semiconductor switching element Q5 is connected to the third input/output terminal 13, the source terminal of the fifth semiconductor switching element Q5 is connected to the drain terminal of the sixth semiconductor switching element Q6, and the source terminal of the sixth semiconductor switching element Q6 is connected to the fourth input/output terminal 14.

In the DC-DC converter 1, the drain terminal of the seventh semiconductor switching element Q7 is connected to the third input/output terminal 13, the source terminal of the seventh semiconductor switching element Q7 is connected to the drain terminal of the eighth semiconductor switching element Q8, and the source terminal of the eighth semiconductor switching element Q8 is connected to the fourth input/output terminal 14.

In the DC-DC converter 1, the first to eighth diodes D1-D8 are parasitic diodes for the MOSFETs of the first to eighth semiconductor switching elements Q1-Q8, respectively. Each of the first to eighth diodes D1-D8 includes an anode and a cathode. The anode of each of the first to eighth diodes D1-D8 is connected to the second main terminal (source terminal) of a corresponding one of the first to eighth semiconductor switching elements Q1-Q8. The cathode of each of the first to eighth diodes D1-D8 is connected to the first main terminal (drain terminal) of a corresponding one of the first to eighth semiconductor switching elements Q1-Q8.

In the DC-DC converter 1, the first winding N1 of the transformer Tr1 is connected, via the first capacitor C1, between a connection node of the first and second semiconductor switching element Q1, Q2 and a connection node of the third and fourth semiconductor switching elements Q3, Q4. In the DC-DC converter 1, the second winding N2 of the transformer Tr1 is connected, via the second capacitor C2, between a connection node of the fifth and sixth semiconductor switching elements Q5, Q6 and a connection node of the seventh and eighth semiconductor switching elements Q7, Q8.

The DC-DC converter 1 further includes a first storage circuit 15 and a second storage circuit 16.

The first storage circuit 15 is connected between the first input/output terminal 11 and the second input/output terminal 12. The first storage circuit 15 includes a third capacitor C3. The third capacitor C3 may be, for example, an electrolytic capacitor.

The second storage circuit 16 is connected between the third input/output terminal 13 and the fourth input/output terminal 14. The second storage circuit 16 includes a fourth capacitor C4. The fourth capacitor C4 may be, for example, an electrolytic capacitor.

The DC-DC converter 1 may perform a first conversion operation of converting a first input voltage into a first output voltage and a second conversion operation of converting a second input voltage into a second output voltage. The DC-DC converter 1 changes semiconductor switching elements to switch, among the first to eighth semiconductor switching elements Q1-Q8, depending on whether the DC-DC converter 1 performs the first conversion operation or the second conversion operation. When performing the first conversion operation, the DC-DC converter 1 sets the voltage V1 between the first input/output terminal 11 and the second input/output terminal 12 at a first input voltage and sets the voltage V2 between the third input/output terminal 13 and the fourth input/output terminal 14 at a first output voltage. When performing the second conversion operation, the DC-DC converter 1 sets the voltage V2 between the third input/output terminal 13 and the fourth input/output terminal 14 at a second input voltage and sets the voltage V1 between the first input/output terminal 11 and the second input/output terminal 12 at a second output voltage. When performing the first conversion operation, the DC-DC converter 1 converts the first input voltage (voltage V1) applied between the first input/output terminal 11 and the second input/output terminal 12 into a first output voltage (voltage V2), which is different from the first input voltage (voltage V1), and delivers the first output voltage to between the third input/output terminal 13 and the fourth input/output terminal 14. On the other hand, when performing the second conversion operation, the DC-DC converter 1 converts the second input voltage (voltage V2) applied between the third input/output terminal 13 and the fourth input/output terminal 14 into a second output voltage (voltage V1), which is different from the second input voltage (voltage V2), and delivers the second output voltage to between the first input/output terminal 11 and the second input/output terminal 12.

The detector circuit 2 detects, as the output voltage of the DC-DC converter 1, the first output voltage (voltage V2) between the third input/output terminal 13 and fourth input/output terminal 14 of the DC-DC converter 1 while the DC-DC converter 1 is performing the first conversion operation to detect a predetermined change in the output voltage (voltage V2). The predetermined change may be, for example, a change in the output voltage (voltage V2) from a first voltage value (of 350 V, for example) into a second voltage value (of 300 V, for example). The second voltage value is different from, and smaller than, the first voltage value. The detector circuit 2 includes, for example, a resistance divider circuit connected across the fourth capacitor C4, a reference voltage source, and a comparator for comparing the output voltage of the DC-DC converter 1, which has been detected by the resistance divider circuit, with the voltage of the reference voltage source.

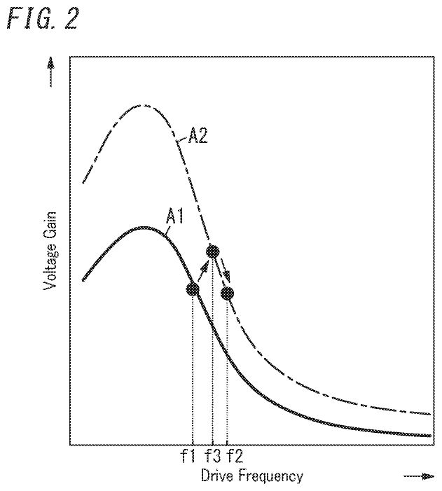

The control circuit 3 controls the DC-DC converter 1 as described above. More specifically, the control circuit 3 controls the first to eighth semiconductor switching elements Q1-Q8. The control circuit 3 has, as operation modes thereof: a first control mode in which the control circuit 3 controls the DC-DC converter 1 at a first drive frequency f1 (refer to FIG. 2); a second control mode in which the control circuit 3 controls the DC-DC converter 1 at a second drive frequency f2 (refer to FIG. 2); and a third control mode in which the control circuit 3 controls the DC-DC converter 1 at a third drive frequency f3 (refer to FIG. 2). The second drive frequency f2 is higher than the first drive frequency f1. The third drive frequency f3 is higher than the first drive frequency f1 and different from the second drive frequency f2. In this embodiment, the third drive frequency f3 is lower than the second drive frequency f2. For example, the first drive frequency f1, the second drive frequency f2, and the third drive frequency f3 may be 220 kHz, 250 kHz, and 240 kHz, respectively. Note that these numerical values of the first drive frequency f1, the second drive frequency f2, and the third drive frequency f3 are only examples and should not be construed as limiting. The first control mode, the second control mode, and the third control modes are operation modes when the DC-DC converter 1 is made to perform the first conversion operation. The control circuit 3 is configured to change the operation mode from the first control mode into the second control mode when the detector circuit 2 detects a predetermined change in the output voltage (voltage V2) while the control circuit 3 is operating in the first control mode. The control circuit 3 controls the DC-DC converter 1 in the third control mode in the process of changing, in response of the detection of the predetermined change, the operation mode from the first control mode to the second control mode before starting to control the DC-DC converter 1 in the second control mode.

The control circuit 3 is configured to apply first to eighth control voltages (gate voltages) to the first to eighth semiconductor switching elements Q1-Q8, respectively. The control circuit 3 includes, for example, first to eighth drive circuits for applying the first to eighth control voltages to the first to eighth semiconductor switching elements Q1-Q8, respectively, and a control unit for controlling the first to eighth drive circuits. The first to eighth control voltages are voltages applied between the respective control terminals and respective second main terminals of the first to eighth semiconductor switching elements Q1-Q8. The first to eighth control voltages may be, for example, voltages, each of which changes its voltage level alternately between a voltage value (of 10 V, for example) higher than the threshold voltage (gate threshold voltage) of the first to eighth semiconductor switching elements Q1-Q8 and a voltage value (of 0 V, for example) lower than the threshold voltage thereof. A switching frequency as a frequency for the first to eighth control voltages may, for example, fall within the range from 100 kHz to 300 kHz. The duty, which is defined to be the ratio of a period in which the voltage value is higher than the threshold voltage to one cycle of the first to eighth control voltages (which is the sum of a period in which the voltage value is higher than the threshold voltage and a period in which the voltage value is lower than the threshold voltage) may, for example, fall within the range from 0.1 to 0.9. The first to eighth drive circuits are controlled by the control unit and output first to eighth control voltages, respectively.

The agent that performs the functions of the control unit includes a computer system. The computer system includes a single computer or a plurality of computers. The computer system may include a processor and a memory as principal hardware components thereof. The agent performs the functions of the control unit according to the present disclosure by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive (magnetic disk), any of which is readable for the computer system. The processor of the computer system may be made up of a single or a plurality of electronic circuits including a semiconductor integrated circuit (IC) or a large-scale integrated circuit (LSI). Those electronic circuits may be either integrated together on a single chip or distributed on multiple chips, whichever is appropriate. Those multiple chips may be aggregated together in a single device or distributed in multiple devices without limitation.

In a situation where the DC-DC converter 1 is made to perform the first conversion operation, the control circuit 3 is configured to make the DC-DC converter 1 operate in a full-bridge control mode, a voltage doubler control mode, and a half-bridge control mode. In the power conversion system 100 according to the exemplary embodiment, the first control mode and the second control mode may be, for example, the full-bridge control mode and the voltage doubler control mode, respectively. The DC-DC converter 1 has a voltage gain varying according to the drive frequency. As used herein, the “drive frequency” refers to a switching frequency. More specifically, the “drive frequency” herein refers to the switching frequency of a semiconductor switching element to switch among the plurality of semiconductor switching elements (namely, the first to eighth semiconductor switching elements Q1-Q8). As used herein, the “voltage gain” refers to the ratio of the output voltage to the input voltage of the DC-DC converter 1, i.e., a value calculated by dividing the output voltage by the input voltage.

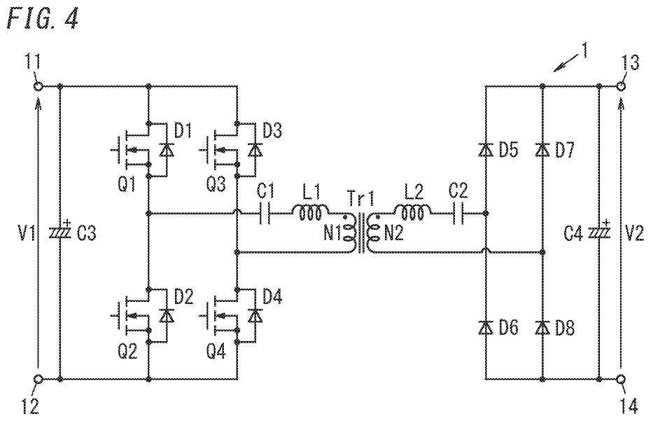

When the DC-DC converter 1 is made to perform the first conversion operation, the control circuit 3 turns OFF, in the full-bridge control mode, the fifth semiconductor switching element Q5, the sixth semiconductor switching element Q6, the seventh semiconductor switching element Q7, and the eighth semiconductor switching element Q8, thereby causing the first semiconductor switching element Q1, the second semiconductor switching element Q2, the third semiconductor switching element Q3, and the fourth semiconductor switching element Q4 to be switched. FIG. 4 is an equivalent circuit diagram of the DC-DC converter 1 for use in a situation where the control circuit 3 controls the DC-DC converter 1 in the full-bridge control mode.

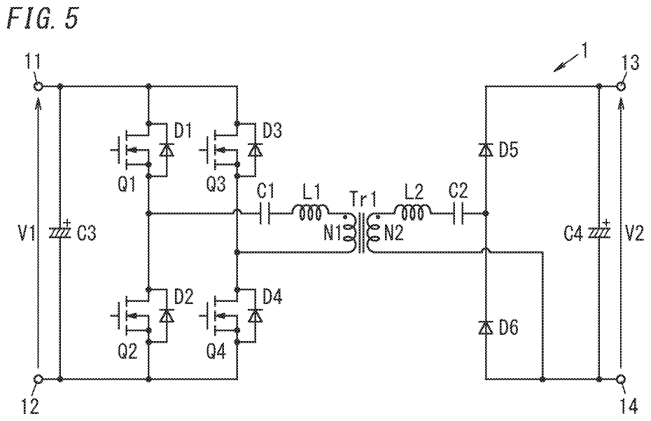

When the DC-DC converter 1 is made to perform the first conversion operation, the control circuit 3 turns OFF, in the voltage doubler control mode, the fifth semiconductor switching element Q5, the sixth semiconductor switching element Q6, and the seventh semiconductor switching element Q7, and turns ON the eighth semiconductor switching element Q8, thereby causing the first semiconductor switching element Q1, the second semiconductor switching element Q2, the third semiconductor switching element Q3, and the fourth semiconductor switching element Q4 to be switched. FIG. 5 is an equivalent circuit diagram of the DC-DC converter 1 for use in a situation where the control circuit 3 controls the DC-DC converter 1 in the voltage doubler control mode.

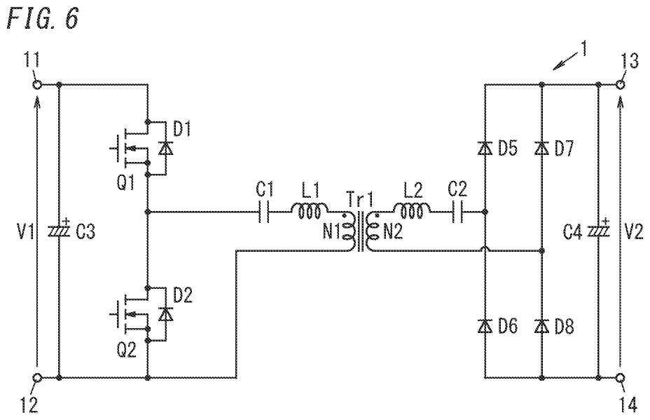

When the DC-DC converter 1 is made to perform the first conversion operation, the control circuit 3 turns OFF, in the half-bridge control mode, the third semiconductor switching element Q3, turns ON the fourth semiconductor switching element Q4, and turns OFF the fifth semiconductor switching element Q5, the sixth semiconductor switching element Q6, the seventh semiconductor switching element Q7, and the eighth semiconductor switching element Q8, thereby causing the first semiconductor switching element Q1 and the second semiconductor switching element Q2 to be switched to prevent respective ON-state periods of the first semiconductor switching element Q1 and the second semiconductor switching element Q2 from overlapping with each other. FIG. 6 is an equivalent circuit diagram of the DC-DC converter 1 for use in a situation where the control circuit 3 controls the DC-DC converter 1 in the half-bridge control mode.

When the control circuit 3 makes the DC-DC converter 1 perform the first conversion operation, the voltage gain to make the DC-DC converter 1 perform the first conversion operation is calculated by dividing the voltage V2 by the voltage V1. When the control circuit 3 makes the DC-DC converter 1 perform the first conversion operation, the voltage gain when the control circuit 3 controls the DC-DC converter 1 in the voltage doubler control mode is approximately double the voltage gain when the control circuit 3 controls the DC-DC converter 1 in the full-bridge control mode and the voltage gain when the control circuit 3 controls the DC-DC converter 1 in the half-bridge control mode is approximately one half of the voltage gain when the control circuit 3 controls the DC-DC converter 1 in the full-bridge control mode. When the control circuit 3 makes the DC-DC converter 1 perform the first conversion operation, the voltage gain when the control circuit 3 controls the DC-DC converter 1 in the full-bridge control mode is approximately one half of the voltage gain when the control circuit 3 controls the DC-DC converter 1 in the voltage doubler control mode. When the control circuit 3 makes the DC-DC converter 1 perform the first conversion operation, the voltage gain when the control circuit 3 controls the DC-DC converter 1 in the full-bridge control mode is approximately double the voltage gain when the control circuit 3 controls the DC-DC converter 1 in the half-bridge control mode.

In the following description, when the control circuit 3 makes the DC-DC converter 1 perform the first conversion operation, the full-bridge control mode, the voltage doubler control mode, and the half-bridge control mode will be hereinafter also referred to as a “first full-bridge control mode,” a “first voltage doubler control mode,” and a “first half-bridge control mode,” respectively.

In a situation where the DC-DC converter 1 is made to perform the second conversion operation, the control circuit 3 is configured to make the DC-DC converter 1 operate in a second full-bridge control mode, a second voltage doubler control mode, and a second half-bridge control mode.

When the DC-DC converter 1 is made to perform the second conversion operation, the control circuit 3 turns OFF, in the second full-bridge control mode, the first semiconductor switching element Q1, the second semiconductor switching element Q2, the third semiconductor switching element Q3, and the fourth semiconductor switching element Q4, thereby causing the fifth semiconductor switching element Q5, the sixth semiconductor switching element Q6, the seventh semiconductor switching element Q7, and the eighth semiconductor switching element Q8 to be switched.

When the DC-DC converter 1 is made to perform the second conversion operation, the control circuit 3 turns OFF, in the second voltage doubler control mode, the first semiconductor switching element Q1, the second semiconductor switching element Q2, and the third semiconductor switching element Q3 and turns ON the fourth semiconductor switching element Q4, thereby causing the fifth semiconductor switching element Q5, the sixth semiconductor switching element Q6, the seventh semiconductor switching element Q7, and the eighth semiconductor switching element Q8 to be switched.

When the DC-DC converter 1 is made to perform the second conversion operation, the control circuit 3 turns OFF, in the half-bridge control mode, the seventh semiconductor switching element Q7, turns ON the eighth semiconductor switching element Q8, and turns OFF the first semiconductor switching element Q1, the second semiconductor switching element Q2, the third semiconductor switching element Q3, and the fourth semiconductor switching element Q4, thereby causing the fifth semiconductor switching element Q5 and the sixth semiconductor switching element Q6 to be switched to prevent respective ON-state periods of the fifth semiconductor switching element Q5 and the sixth semiconductor switching element Q6 from overlapping with each other.

(3) Operation of Power Conversion System

(3.1) In the Case of First Full-Bridge Control Mode

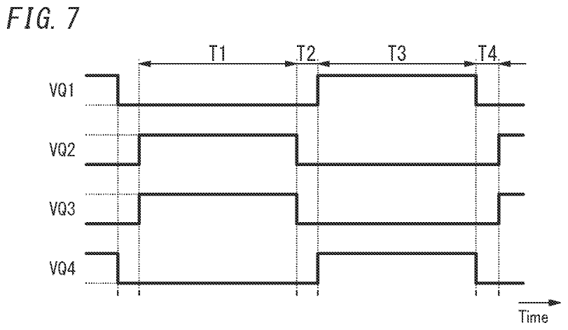

It will be described with reference to FIGS. 7-11 how the DC-DC converter 1 operates when the control circuit 3 controls the DC-DC converter 1 in the first full-bridge control mode.

FIG. 7 is a timing chart showing a first control voltage VQ1, a second control voltage VQ2, a third control voltage VQ3, and a fourth control electrically VQ4 for the first semiconductor switching element Q1, the second semiconductor switching element Q2, the third semiconductor switching element Q3, and the fourth semiconductor switching element Q4, respectively, in a situation where the control circuit 3 controls the DC-DC converter 1 in the first full-bridge control mode. The control circuit 3 repeatedly performs the control for first to fourth periods T1-T4 in multiple cycles. The first period T1 is a period in which the first semiconductor switching element Q1 is turned OFF, the second semiconductor switching element Q2 is turned ON, the third semiconductor switching element Q3 is turned ON, and the fourth semiconductor switching element Q4 is turned OFF. The second period T2 is a period in which the first semiconductor switching element Q1 is turned OFF, the second semiconductor switching element Q2 is turned OFF, the third semiconductor switching element Q3 is turned OFF, and the fourth semiconductor switching element Q4 is turned OFF. The third period T3 is a period in which the first semiconductor switching element Q1 is turned ON, the second semiconductor switching element Q2 is turned OFF, the third semiconductor switching element Q3 is turned OFF, and the fourth semiconductor switching element Q4 is turned ON. The fourth period T4 is a period in which the first semiconductor switching element Q1 is turned OFF, the second semiconductor switching element Q2 is turned OFF, the third semiconductor switching element Q3 is turned OFF, and the fourth semiconductor switching element Q4 is turned OFF.

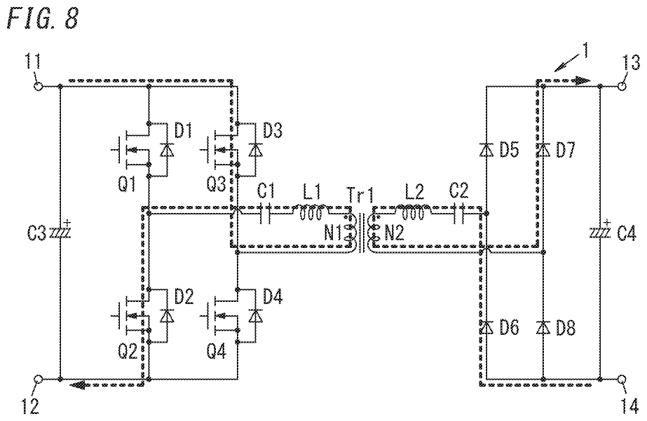

In the first period T1, a current flows through the DC-DC converter 1 along the path indicated by the dotted arrow in FIG. 8. Specifically, the current flows through the DC-DC converter 1 along the path that follows the first input/output terminal 11, the third semiconductor switching element Q3, the first winding N1, the first inductor L1, the first capacitor C1, the second semiconductor switching element Q2, and the second input/output terminal 12 in this order. In addition, the current also flows through the DC-DC converter 1 along the path that follows the fourth input/output terminal 14, the sixth diode D6, the second capacitor C2, the second inductor L2, the second winding N2, the seventh diode D7, and the third input/output terminal 13 in this order.

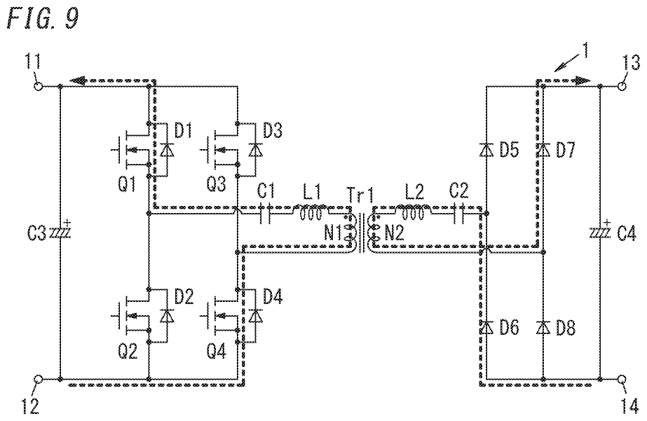

In the second period T2, a current first flows through the DC-DC converter 1 along the path indicated by the dotted arrow in FIG. 9. Specifically, the current flows through the DC-DC converter 1 along the path that follows the second input/output terminal 12, the fourth diode D4, the first winding N1, the first inductor L1, the first capacitor C1, the first diode D1, and the first input/output terminal 11 in this order. In addition, the current also flows through the DC-DC converter 1 along the path that follows the fourth input/output terminal T4, the sixth diode D6, the second capacitor C2, the second inductor L2, the second winding N2, the seventh diode D7, and the third input/output terminal 13 in this order.

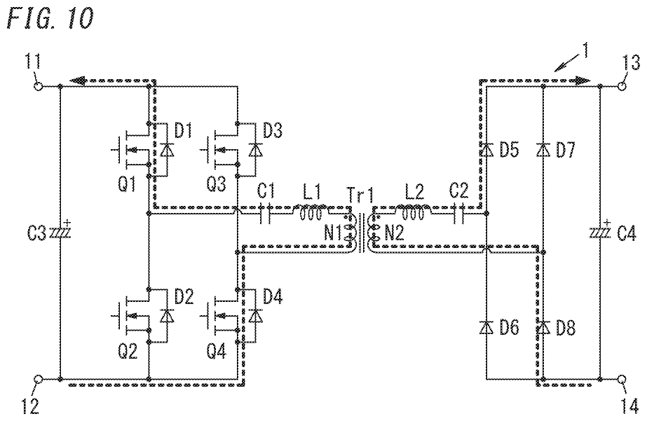

In the DC-DC converter 1, the current flowing through the second winding N2 of the transformer Tr1 makes zero crossing halfway through the second period T2, thus causing the current flowing through the second winding N2 to invert its direction. Consequently, the current flows through the DC-DC converter 1 along the path indicated by the dotted arrow in FIG. 10. Specifically, the current flows through the DC-DC converter 1 along the path that follows the second input/output terminal 12, the fourth diode D4, the first winding N1, the first inductor L1, the first capacitor C1, the first diode D1, and the first input/output terminal 11 in this order. In addition, the current also flows through the DC-DC converter 1 along the path that follows the fourth input/output terminal T4, the eighth diode D8, the second winding N2, the second inductor L2, the second capacitor C2, the fifth diode D5, and the third input/output terminal 13 in this order.

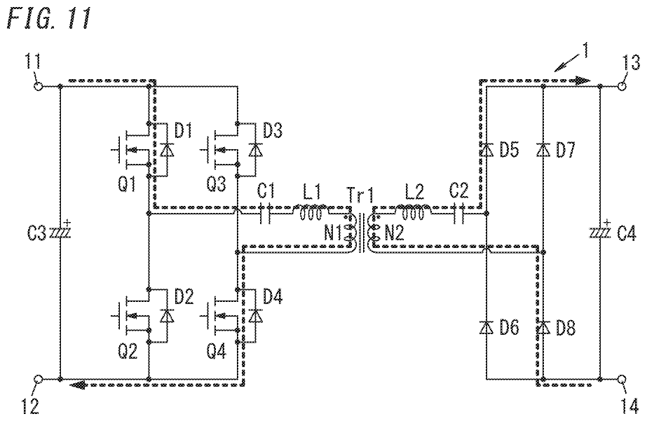

In the third period T3, a current flows through the DC-DC converter 1 along the path indicated by the dotted arrow in FIG. 11. Specifically, the current flows through the DC-DC converter 1 along the path that follows the first input/output terminal 11, the first semiconductor switching element Q1, the first capacitor C1, the first inductor L1, the first winding N1, the fourth semiconductor switching element Q4, and the second input/output terminal 12 in this order. In addition, the current also flows through the DC-DC converter 1 along the path that follows the fourth input/output terminal T4, the eighth diode D8, the second winding N2, the second inductor L2, the second capacitor C2, the fifth diode D5, and the third input/output terminal 13 in this order. In the third period T3 in which the first semiconductor switching element Q1 and the fourth semiconductor switching element Q4 are ON and the second semiconductor switching element Q2 and the third semiconductor switching element Q3 are OFF, the voltage across the first winding N1 and the voltage across the second winding N2 each have a different polarity from in the first period T1 in which the first semiconductor switching element Q1 and the fourth semiconductor switching element Q4 are OFF and the second semiconductor switching element Q2 and the third semiconductor switching element Q3 are ON.

In the fourth period T4, the current flows through the first winding N1 of the transformer Tr1 and the current flows through the second winding N2 in the DC-DC converter 1 in opposite directions from in the second period T2.

(3.2) In the Case of First Voltage Doubler Control Mode

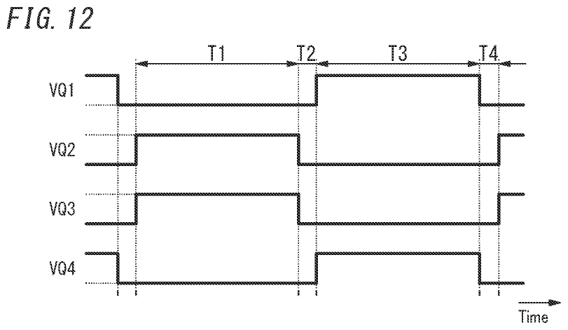

Next, it will be described with reference to FIGS. 12-16 how the DC-DC converter 1 operates when the control circuit 3 controls the DC-DC converter 1 in the first voltage doubler control mode.

FIG. 12 is a timing chart showing a first control voltage VQ1, a second control voltage VQ2, a third control voltage VQ3, and a fourth control electrically VQ4 for the first semiconductor switching element Q1, the second semiconductor switching element Q2, the third semiconductor switching element Q3, and the fourth semiconductor switching element Q4, respectively, in a situation where the control circuit 3 controls the DC-DC converter 1 in the first voltage doubler control mode. The control circuit 3 repeatedly performs the control for first to fourth periods T1-T4 in multiple cycles. The first period T1 is a period in which the first semiconductor switching element Q1 is turned OFF, the second semiconductor switching element Q2 is turned ON, the third semiconductor switching element Q3 is turned ON, and the fourth semiconductor switching element Q4 is turned OFF. The second period T2 is a period in which the first semiconductor switching element Q1 is turned OFF, the second semiconductor switching element Q2 is turned OFF, the third semiconductor switching element Q3 is turned OFF, and the fourth semiconductor switching element Q4 is turned OFF. The third period T3 is a period in which the first semiconductor switching element Q1 is turned ON, the second semiconductor switching element Q2 is turned OFF, the third semiconductor switching element Q3 is turned OFF, and the fourth semiconductor switching element Q4 is turned ON. The fourth period T4 is a period in which the first semiconductor switching element Q1 is turned OFF, the second semiconductor switching element Q2 is turned OFF, the third semiconductor switching element Q3 is turned OFF, and the fourth semiconductor switching element Q4 is turned OFF.

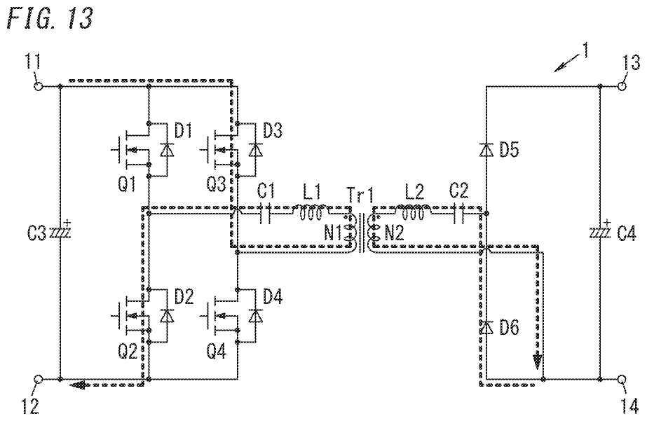

In the first period T1, a current flows through the DC-DC converter 1 along the path indicated by the dotted arrow in FIG. 13. Specifically, the current flows through the DC-DC converter 1 along the path that follows the first input/output terminal 11, the third semiconductor switching element Q3, the first winding N1, the first inductor L1, the first capacitor C1, the second semiconductor switching element Q2, and the second input/output terminal 12 in this order. In addition, the current also flows through the DC-DC converter 1 along the path that follows the sixth diode D6, the second capacitor C2, the second inductor L2, and the second winding N2 in this order.

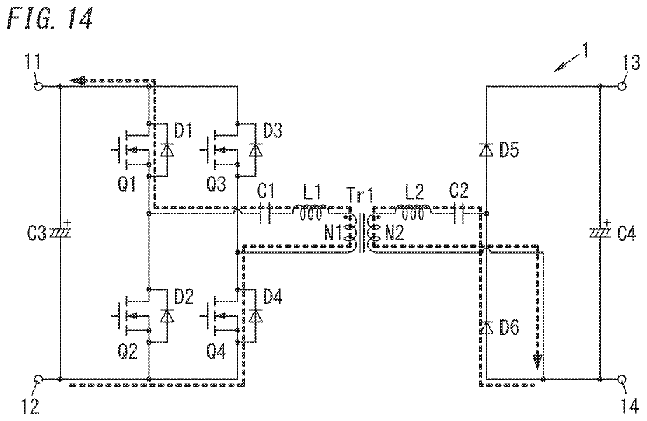

In the second period T2, a current flows through the DC-DC converter 1 along the path indicated by the dotted arrow in FIG. 14. Specifically, the current flows through the DC-DC converter 1 along the path that follows the second input/output terminal 12, the fourth diode D4, the first winding N1, the first inductor L1, the first capacitor C1, the first diode D1, and the first input/output terminal 11 in this order. In addition, the current also flows through the DC-DC converter 1 along the path that follows the sixth diode D6, the second capacitor C2, the second inductor L2, and the second winding N2 in this order.

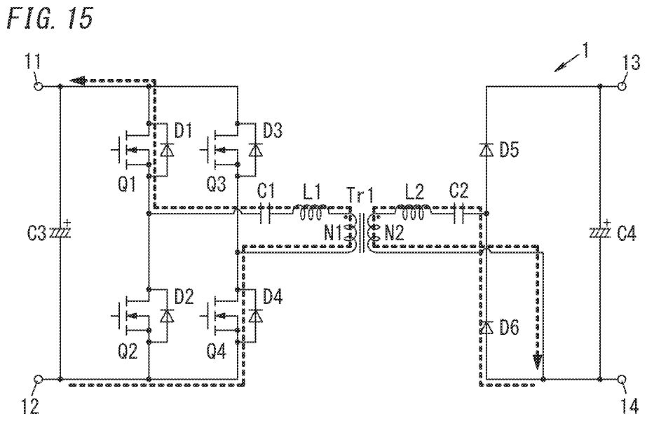

In the third period T3, a current flows through the DC-DC converter 1 along the path indicated by the dotted arrow in FIG. 15. Specifically, the current flows through the DC-DC converter 1 along the path that follows the second input/output terminal 12, the fourth diode D4, the first winding N1, the first inductor L1, the first capacitor C1, the first diode D1, and the first input/output terminal 11 in this order. In addition, the current also flows through the DC-DC converter 1 along the path that follows the sixth diode D6, the second capacitor C2, the second inductor L2, and the second winding N2 in this order.

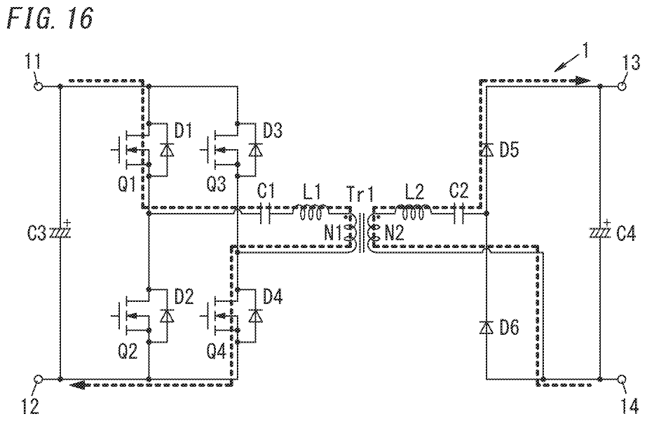

In the DC-DC converter 1, the current flowing through the first winding N1 of the transformer Tr1 and the current flowing through the second winding N2 of the transformer Tr1 each make zero crossing halfway through the third period T3, thus causing the current flowing through the first winding N1 and the current flowing through the second winding N2 to invert their directions. Consequently, the current flows through the DC-DC converter 1 along the path indicated by the dotted arrow in FIG. 16. Specifically, the current flows through the DC-DC converter 1 along the path that follows the first input/output terminal 11, the first semiconductor switching element Q1, the first capacitor C1, the first inductor L1, the first winding N1, the fourth semiconductor switching element Q4, and the second input/output terminal 12 in this order. In addition, the current also flows through the DC-DC converter 1 along the path that follows the fourth input/output terminal T4, the second winding N2, the second inductor L2, the second capacitor C2, the fifth diode D5, and the third input/output terminal 13 in this order.

In the fourth period T4, the current flows through the first winding N1 of the transformer Tr1 and the current flows through the second winding N2 in the DC-DC converter 1 in opposite directions from in the second period T2.

(3.3) In the Case of First Half-Bridge Control Mode

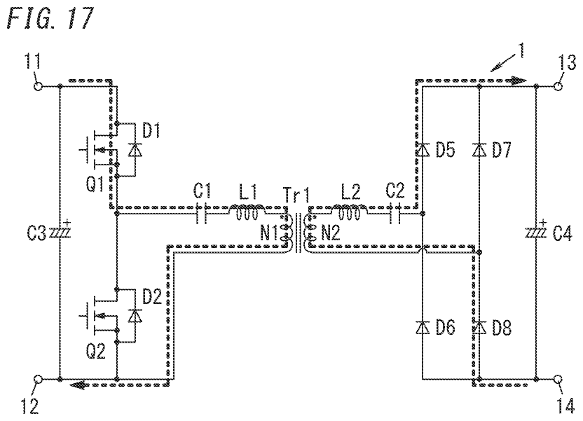

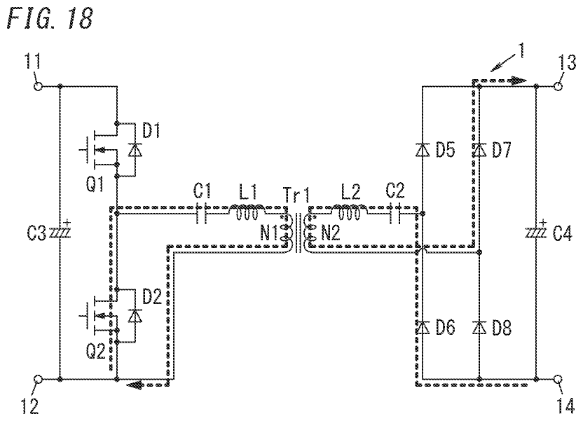

Next, it will be described with reference to FIGS. 17 and 18 how the DC-DC converter 1 operates when the control circuit 3 controls the DC-DC converter 1 in the first half-bridge control mode.

The control circuit 3 repeatedly performs control for first and second periods in multiple cycles. The first period is a period in which the first semiconductor switching element Q1 is turned ON and the second semiconductor switching element Q2 is turned OFF. The second period is a period in which the first semiconductor switching element Q1 is turned OFF and the second semiconductor switching element Q2 is turned ON.

In the first period, a current flows through the DC-DC converter 1 along the path indicated by the dotted arrow in FIG. 17. Specifically, the current flows through the DC-DC converter 1 along the path that follows the first input/output terminal 11, the first semiconductor switching element Q1, the first capacitor C1, the first inductor L1, the first winding N1, and the second input/output terminal 12 in this order. In addition, the current also flows through the DC-DC converter 1 along the path that follows the fourth input/output terminal T4, the eighth diode D8, the second winding N2, the second inductor L2, the second capacitor C2, the fifth diode D5, and the third input/output terminal 13 in this order.

In the second period, a current flows through the DC-DC converter 1 along the path indicated by the dotted arrow in FIG. 18. Specifically, a current flows through the DC-DC converter 1 along the path that follows the second semiconductor switching element Q2, the first capacitor C1, the first inductor L1, and the first winding N1 in this order. In addition, a current also flows through the DC-DC converter 1 along the path that follows the fourth input/output terminal T4, the sixth diode D6, the second capacitor C2, the second inductor L2, the second winding N2, the seventh diode D7, and the third input/output terminal 13 in this order.

(3.4) In the Case of Second Full-Bridge Control Mode

When the control circuit 3 controls the DC-DC converter 1 in the second full-bridge control mode, the first to eighth semiconductor switching elements Q1-Q8 are just controlled to invert the respective levels of the input and output voltages for the DC-DC converter 1 compared to a situation where the control circuit 3 controls the DC-DC converter 1 in the first full-bridge control mode. Thus, description thereof will be omitted herein.

(3.5) In the Case of Second Voltage Doubler Control Mode

When the control circuit 3 controls the DC-DC converter 1 in the second voltage doubler control mode, the first to eighth semiconductor switching elements Q1-Q8 are just controlled to invert the respective levels of the input and output voltages for the DC-DC converter 1 compared to a situation where the control circuit 3 controls the DC-DC converter 1 in the first voltage doubler control mode. Thus, description thereof will be omitted herein.

(3.6) In the Case of Second Half-Bridge Control Mode

When the control circuit 3 controls the DC-DC converter 1 in the second half-bridge control mode, the first to eighth semiconductor switching elements Q1-Q8 are just controlled to invert the respective levels of the input and output voltages for the DC-DC converter 1 compared to a situation where the control circuit 3 controls the DC-DC converter 1 in the first half-bridge control mode. Thus, description thereof will be omitted herein.

(3.7) When Transition is Made from First Control Mode to Second Control Mode

In response to detection of a predetermined change in output voltage (voltage V2) by the detector circuit 2 while the control circuit 3 is operating in the first control mode, the control circuit 3 changes the operation mode (i.e., makes a transition) from the first control mode into the second control mode. The control circuit 3 controls the DC-DC converter 1 in the third control mode, in the process of changing, in response of detection of the predetermined change, the operation mode from a first control mode into a second control mode before starting to control the DC-DC converter 1 in the second control mode.

For the control circuit 3, the first control mode is the first full-bridge control mode, and the second control mode is the first voltage doubler control mode. More specifically, for the control circuit 3, the first control mode is a first full-bridge control mode in which the control circuit 3 controls the first to fourth semiconductor switching elements Q1-Q4 of the DC-DC converter 1 at a first drive frequency f1 (first switching frequency). Also, for the control circuit 3, the second control mode is a first voltage doubler control mode in which the control circuit 3 controls the first to fourth semiconductor switching elements Q1-Q4 of the DC-DC converter 1 at a second drive frequency f2 (second switching frequency). Furthermore, for the control circuit 3, the third control mode is a first voltage doubler control mode in which the control circuit 3 controls the first to fourth semiconductor switching elements Q1-Q4 of the DC-DC converter 1 at a third drive frequency f3 (third switching frequency).

FIG. 2 is a graph showing how the voltage gain changes with the drive frequency for the DC-DC converter 1. In FIG. 2, a relationship between the voltage gain and the drive frequency in the first full-bridge control mode is indicated by the solid curve A1 and a relationship between the voltage gain and the drive frequency in the first voltage doubler control mode is indicated by the one-dot-chain curve A2. In addition, the first drive frequency f1, the second drive frequency f2, and the third drive frequency f3 are also shown in FIG. 2.

As for the operation of the DC-DC converter 1 in a range where the voltage gain decreases as the drive frequency increases, the voltage gain and an overcurrent both tend to decrease relatively when the load is light.

In the power conversion system 100, the control circuit 3 may be configured to, when the first drive frequency f1 and the second drive frequency f2 are both equal to or higher than a predetermined frequency (e.g., 300 kHz), change the operation mode directly from the first control mode into the second control mode, not via the third control mode, during the process described above. More specifically, the control circuit 3 may be configured, while making a transition from the first full-bridge control mode in which the control circuit 3 controls the first to fourth semiconductor switching elements Q1-Q4 of the DC-DC converter 1 at the first drive frequency f1 (first switching frequency) into the first voltage doubler control mode in which the control circuit 3 controls the first to fourth semiconductor switching elements Q1-Q4 of the DC-DC converter 1 at the second drive frequency f2 (second switching frequency), not to perform the first voltage doubler control mode in which the control circuit 3 controls the first to fourth semiconductor switching elements Q1-Q4 of the DC-DC converter 1 at the third drive frequency f3 (third switching frequency). The predetermined frequency may be, for example, a drive frequency of the DC-DC converter 1 that makes an overcurrent, which is generated when a transition is made from the first control mode to the second control mode not via the third control mode, equal to or less than 120% of a maximum permissible current for the first capacitor C1 and the second capacitor C2.

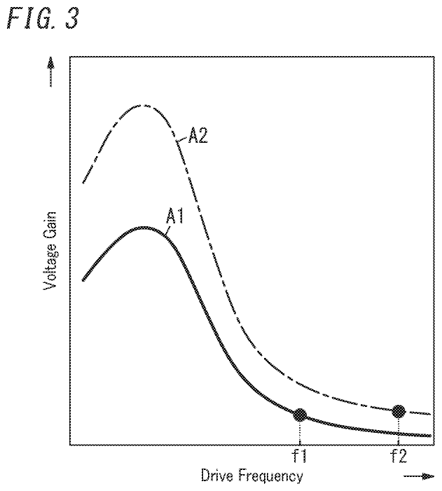

FIG. 3 is a graph showing how the voltage gain changes with the drive frequency for the DC-DC converter 1. In FIG. 3, a relationship between the voltage gain and the drive frequency in the first full-bridge control mode is indicated by the solid curve A1 and a relationship between the voltage gain and the drive frequency in the first voltage doubler control mode is indicated by the one-dot-chain curve A2. In addition, the first drive frequency f1 (e.g., 310 kHz) and the second drive frequency f2 (e.g., 1 MHz) are also shown in FIG. 3.

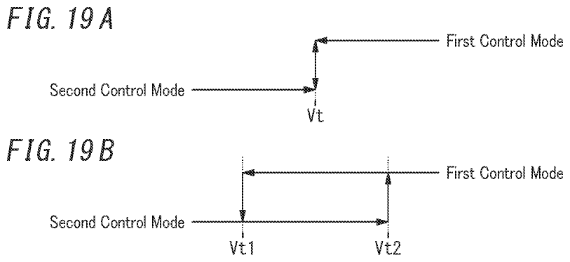

In the power conversion system 100, the control circuit 3 may also be configured to, when the detector circuit 2 detects a second predetermined change (decrease), which is different from a first predetermined change (increase) as the predetermined change in the output voltage (voltage V2) while the control circuit 3 is operating in the second control mode, change the operation mode from the second control mode into the first control mode. In this case, if the detector circuit 2 uses the same threshold value Vt for the first predetermined change and the second predetermined change to make a transition either from the first control mode to the second control mode or from the second control mode to the first control mode, for example, then chances are that chattering occurs to cause the switch between the first control mode and the second control mode to be repeated endlessly as shown in FIG. 19A. Thus, to reduce the chances of causing such chattering, the power conversion system 100 makes a first threshold value Vt1 (e.g., 298 V) for use to detect the first predetermined change and a second threshold value Vt2 (e.g., 302 V) for use to detect the second predetermined change different from each other as shown in FIG. 19B. The detector circuit 2 may include, for example: a resistance divider circuit; a first comparator, of which a non-inverting input terminal is connected to an output terminal of the resistance divider circuit; a second comparator, of which an inverting input terminal is connected to the output terminal of the resistance divider circuit; a first reference voltage source, which is connected to the inverting input terminal of the first comparator and outputs the first threshold value Vt1; and a second reference voltage source, which is connected to the non-inverting input terminal of the second comparator and outputs the second threshold value Vt2. Alternatively, the detector circuit 2 may also be a wind comparator.

(4) Recapitulation

In the power conversion system 100 according to the exemplary embodiment described above, the control circuit 3 has, as operation modes thereof: a first control mode in which the control circuit 3 controls the DC-DC converter 1 at a first drive frequency f1; a second control mode in which the control circuit 3 controls the DC-DC converter 1 at a second drive frequency f2 higher than the first drive frequency f1; and a third control mode in which the control circuit 3 controls the DC-DC converter 1 at a third drive frequency f3 higher than the first drive frequency f1 and different from the second drive frequency f2. The control circuit 3 is configured to change the operation mode from the first control mode into the second control mode when the detector circuit 2 detects a predetermined change in the output voltage (voltage V2) while the control circuit 3 is operating in the first control mode. The control circuit 3 controls the DC-DC converter 1 in the third control mode in the process of changing, in response to detection of the predetermined change, the operation mode from the first control mode into the second control mode before starting to control the DC-DC converter 1 in the second control mode. This allows the power conversion system 100 according to the exemplary embodiment to reduce the chances of generating an overcurrent. More specifically, the power conversion system 100 according to the exemplary embodiment may reduce the chances of generating an overcurrent while the control circuit 3 is changing the control mode for controlling the DC-DC converter 1 from the first control mode into the second control mode.

The foregoing description of embodiments also discloses the following control method.

The control method is a method for controlling a power conversion system 100. The power conversion system 100 includes a DC-DC converter 1 and a detector circuit 2. The DC-DC converter 1 includes a transformer Tr1, a first capacitor C1, and a second capacitor C2. The transformer Tr1 includes a first winding N1 and a second winding N2 and has a first leakage inductance on the first winding N1 and a second leakage inductance on the second winding N2. The first capacitor C1 serves as a resonant capacitor and is connected to the first winding N1. The second capacitor C2 serves as a resonant capacitor and is connected to the second winding N2. The detector circuit 2 detects a change in output voltage (voltage V2) of the DC-DC converter 1. The control method includes controlling the DC-DC converter 1 in a third control mode, in a process of changing, in response of detection of a predetermined change in the output voltage (voltage V2) by the detector circuit 2, an operation mode from a first control mode into a second control mode before starting to control the DC-DC converter 1 in the second control mode. The first control mode is an operation mode in which the DC-DC converter 1 is controlled at a first drive frequency f1. The second control mode is an operation mode in which the DC-DC converter 1 is controlled at a second drive frequency f2 higher than the first drive frequency f1. The third control mode is an operation mode in which the DC-DC converter 1 is controlled at a third drive frequency f3 higher than the first drive frequency f1 and different from the second drive frequency f2.

This control method may reduce the chances of generating an overcurrent.

(Variations)

Note that the embodiment described above is only an exemplary one of various embodiments of the present disclosure and should not be construed as limiting. Rather, the exemplary embodiment may be readily modified in various manners depending on a design choice or any other factor without departing from the scope of the present disclosure.

(First Variation)

A power conversion system 100 according to a first variation of the exemplary embodiment has the same circuit configuration as the power conversion system 100 according to the exemplary embodiment. Thus, illustration and description thereof will be omitted herein.

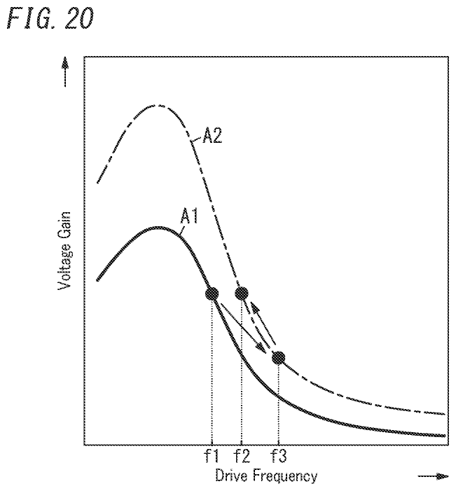

In the power conversion system 100 according to the first variation of the exemplary embodiment, the third drive frequency f3 at which the control circuit 3 controls the DC-DC converter 1 is set at a frequency higher than the second drive frequency f2 as shown in FIG. 20, which is a difference from the power conversion system 100 according to the exemplary embodiment. The first drive frequency f1, the second drive frequency f2, and the third drive frequency f3 may be, for example, 220 kHz, 250 kHz, and 270 kHz, respectively. However, these numerical values of the first drive frequency f1, the second drive frequency f2, and the third drive frequency f3 are only examples and should not be construed as limiting. In FIG. 20, a relationship between the voltage gain and the drive frequency in the first full-bridge control mode is indicated by the solid curve A1 and a relationship between the voltage gain and the drive frequency in the first voltage doubler control mode is indicated by the one-dot-chain curve A2. In addition, the first drive frequency f1, the second drive frequency f2, and the third drive frequency f3 are also shown in FIG. 20.

In the power conversion system 100 according to the first variation of the exemplary embodiment, the third drive frequency f3 is higher than the second drive frequency f2, thus further reducing the chances of generating an overcurrent, compared to a situation where the third drive frequency f3 is lower than the second drive frequency f2 as in the power conversion system 100 according to the exemplary embodiment.

(Second Variation)

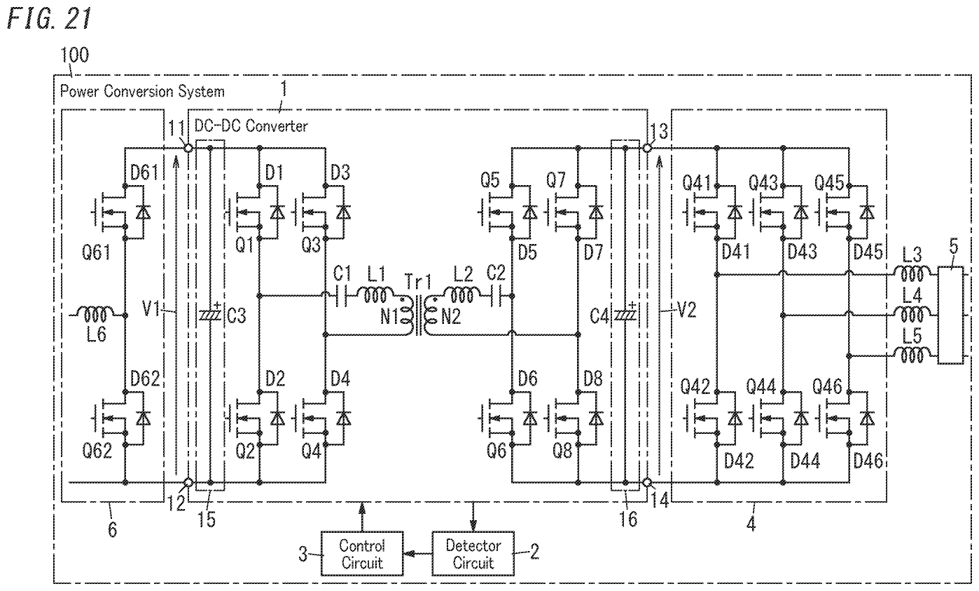

A power conversion system 100 according to a second variation of the exemplary embodiment includes, as shown in FIG. 21, the same DC-DC converter 1 as the power conversion system 100 according to the exemplary embodiment. In the following description, any constituent element of the power conversion system 100 according to the second variation of the exemplary embodiment, having the same function as a counterpart of the power conversion system 100 according to the exemplary embodiment described above, will be designated by the same reference numeral as that counterpart's, and description thereof will be omitted herein.

The power conversion system 100 according to the second variation further includes a bidirectional DC-AC converter 4, which is a difference from the power conversion system 100 according to the exemplary embodiment. The bidirectional DC-AC converter 4 is connected to the DC-DC converter 1. Specifically, the bidirectional DC-AC converter 4 is connected across the fourth capacitor C4 included in the second storage circuit 16 of the DC-DC converter 1. The bidirectional DC-AC converter 4 may perform the operation of converting a DC voltage into a three-phase AC voltage and the operation of converting the three-phase AC voltage into the DC voltage.

The bidirectional DC-AC converter 4 includes a first series circuit, a second series circuit, and a third series circuit, all of which are connected across the fourth capacitor C4 of the DC-DC converter 1. The first series circuit is a series circuit of a first high-side semiconductor switching element Q41 and a first low-side semiconductor switching element Q42. The second series circuit is a series circuit of a second high-side semiconductor switching element Q43 and a second low-side semiconductor switching element Q44. The third series circuit is a series circuit of a third high-side semiconductor switching element Q45 and a third low-side semiconductor switching element Q46. The bidirectional DC-AC converter 4 includes a diode D41 and a diode D42, which are connected antiparallel to the first high-side semiconductor switching element Q41 and the first low-side semiconductor switching element Q42, respectively. The bidirectional DC-AC converter 4 also includes a diode D43 and a diode D44, which are connected antiparallel to the second high-side semiconductor switching element Q43 and the second low-side semiconductor switching element Q44, respectively. The bidirectional DC-AC converter 4 further includes a diode D45 and a diode D46, which are connected antiparallel to the third high-side semiconductor switching element Q45 and the third low-side semiconductor switching element Q46, respectively. The first high-side semiconductor switching element Q41, first low-side semiconductor switching element Q42, second high-side semiconductor switching element Q43, second low-side semiconductor switching element Q44, third high-side semiconductor switching element Q45, and third low-side semiconductor switching element Q46 of the bidirectional DC-AC converter 4 are controlled by a second control circuit, which is provided separately from the control circuit 3 (hereinafter also referred to as a “first control circuit 3”). Not that the second control circuit does not have to be provided separately from the first control circuit 3 but may be provided for the first control circuit 3.

The power conversion system 100 according to the second variation further includes an AC filter 5. The AC filter 5 is connected to the bidirectional DC-AC converter 4 and may also be connected to, for example, a pole transformer of the power grid. The bidirectional DC-AC converter 4 may be connected to the pole transformer via the AC filter 5, for example. The AC filter 5 is a noise filter.

The power conversion system 100 according to the second variation further includes an inductor L3, an inductor L4, and an inductor L5. The inductor L3 is connected between a connection node of the first high-side semiconductor switching element Q41 and the first low-side semiconductor switching element Q42 and the AC filter 5. The inductor L4 is connected between a connection node of the second high-side semiconductor switching element Q43 and the second low-side semiconductor switching element Q44 and the AC filter 5. The inductor L5 is connected between a connection node of the third high-side semiconductor switching element Q45 and the third low-side semiconductor switching element Q46 and the AC filter 5.

The power conversion system 100 according to the second variation further includes a bidirectional chopper circuit 6. The bidirectional chopper circuit 6 is connected across the third capacitor C3 included in the first storage circuit 15 of the DC-DC converter 1.

The bidirectional chopper circuit 6 is a voltage step-up and step-down chopper circuit which may perform a voltage step-down operation (voltage step-down chopper operation) and a voltage step-up operation (voltage step-up chopper operation).

The bidirectional chopper circuit 6 includes a series circuit connected across the third capacitor C3 and consisting of a high-side semiconductor switching element Q61 and a low-side semiconductor switching element Q62. The bidirectional chopper circuit 6 further includes a diode D61 connected antiparallel to the high-side semiconductor switching element Q61, a diode D62 connected antiparallel to the low-side semiconductor switching element Q62, and a reactor L6.

The reactor L6 is connected to a connection node between the high-side semiconductor switching element Q61 and the low-side semiconductor switching element Q62. The power conversion system 100 according to the second variation is a power conditioner compliant with the CHAdeMO® specification. A storage battery of an electric vehicle is connected to a series circuit of the reactor L6 and the low-side semiconductor switching element Q62 in the bidirectional chopper circuit 6.

When performing the voltage step-up operation of transforming the voltage of a storage battery into a voltage higher than the voltage of the storage battery, the bidirectional chopper circuit 6 turns the high-side semiconductor switching element Q61 OFF and alternately turns the low-side semiconductor switching element Q62 ON and OFF at a high frequency. This allows the bidirectional chopper circuit 6 to operate as a voltage step-up chopper circuit.

On the other hand, when performing the voltage step-down operation of transforming the voltage V1 between the first input/output terminal 11 and second input/output terminal 12 of the DC-DC converter 1 into a voltage lower than the voltage V1, the bidirectional chopper circuit 6 turns the low-side semiconductor switching element Q62 OFF and alternately turns the high-side semiconductor switching element Q61 ON and OFF at a high frequency. This allows the bidirectional chopper circuit 6 to operate as a voltage step-down chopper circuit. The high-side semiconductor switching element Q61 and low-side semiconductor switching element Q62 of the bidirectional chopper circuit 6 are controlled by a third control circuit which may be provided separately from the first control circuit 3. Note that the third control circuit does not have to be provided separately from the first control circuit 3 but may be provided for the first control circuit 3.

The power conversion system 100 according to the second variation includes the same DC-DC converter 1, detector circuit 2, and control circuit 3 as the power conversion system 100 according to the exemplary embodiment, thus also reducing the chances of generating an overcurrent.

(Other Variations)

For example, the first to eighth semiconductor switching elements Q1-Q8 do not have to be n-channel MOSFETs but may also be p-channel MOSFETs. The MOSFETs serving as the first to eighth semiconductor switching elements Q1-Q8 do not have to be Si-based MOSFETs but may also be, for example, SiC-based MOSFETs. Furthermore, each of the first to eighth semiconductor switching elements Q1-Q8 does not have to be a MOSFET but may also be, for example, a bipolar transistor, an insulated gate bipolar transistor (IGBT), or a GaN-based gate injection transistor (GIT).

In the power conversion system 100 according to the exemplary embodiment described above, the first control mode and the second control mode are the full-bridge control mode and the voltage doubler control mode, respectively. However, this is only an example and should not be construed as limiting. Alternatively, the first control mode and the second control mode may also be either the half-bridge control mode and the voltage doubler control mode or the half-bridge control mode and the full-bridge control mode, respectively.

The first storage circuit 15 may include a series circuit of two capacitors instead of the third capacitor C3.

The second storage circuit 16 may include a series circuit of two capacitors instead of the fourth capacitor C4.

The DC-DC converter 1 does not have to have the circuit configuration shown in FIG. 1 but may also have a different circuit configuration. For example, the DC-DC converter 1 does not have to be a bidirectional DC-DC converter with the ability to convert the voltage bidirectionally between the pair of the first input/output terminal 11 and the second input/output terminal 12 and the pair of the third input/output terminal 13 and the fourth input/output terminal 14 but may also be a unidirectional DC-DC converter with the ability to convert the voltage unidirectionally. In the latter case, the DC-DC converter 1 does not have to include all of the first to eighth semiconductor switching elements Q1-Q8 but may include, for example, six semiconductor switching elements out of the first to eighth semiconductor switching elements Q1-Q8. Also, the DC-DC converter 1 does not have to include all of the first to eighth diodes D1-D8 but may include six diodes out of the first to eighth diodes D1-D8. Furthermore, the DC-DC converter 1 may include only one of the first and second storage circuits 15, 16.

The bidirectional DC-AC converter 4 does not have to have the circuit configuration shown in FIG. 21 but may also have any other circuit configuration.

The bidirectional chopper circuit 6 does not have to have the circuit configuration shown in FIG. 21 but may also have any other circuit configuration.

(Aspects)

The exemplary embodiment and its variations described above are specific implementations of the following aspects of the present disclosure.

A power conversion system (100) according to a first aspect includes a DC-DC converter (1), a detector circuit (2), and a control circuit (3). The DC-DC converter (1) includes a transformer (Tr1), a first capacitor (C1), and a second capacitor (C2). The transformer (Tr1) includes a first winding (N1) and a second winding (N2) and has a first leakage inductance on the first winding (N1) and a second leakage inductance on the second winding (N2). The first capacitor (C1) serves as a resonant capacitor and is connected to the first winding (N1). The second capacitor (C2) also serves as a resonant capacitor and is connected to the second winding (N2). The detector circuit (2) detects a change in output voltage (voltage V2) of the DC-DC converter (1). The control circuit (3) controls the DC-DC converter (1). The control circuit (3) has, as operation modes thereof: a first control mode in which the control circuit (3) controls the DC-DC converter (1) at a first drive frequency (f1); a second control mode in which the control circuit (3) controls the DC-DC converter (1) at a second drive frequency (f2) higher than the first drive frequency (f1); and a third control mode in which the control circuit (3) controls the DC-DC converter (1) at a third drive frequency (f3) higher than the first drive frequency (f1) and different from the second drive frequency (f2). The control circuit (3) is configured to change the operation mode from the first control mode into the second control mode when the detector circuit (2) detects a predetermined change in the output voltage (voltage V2) while the control circuit (3) is operating in the first control mode. The control circuit (3) controls the DC-DC converter (1) in the third control mode in a process of changing, in response to detection of the predetermined change, the operation mode from the first control mode into the second control mode before starting to control the DC-DC converter (1) in the second control mode.

The power conversion system (100) according to the first aspect may reduce the chances of generating an overcurrent.

In a power conversion system (100) according to a second aspect, which may be implemented in conjunction with the first aspect, the predetermined change is a change in the output voltage (voltage V2) from a first voltage value into a second voltage value. The second voltage value is different from the first voltage value.

In a power conversion system (100) according to a third aspect, which may be implemented in conjunction with the first or second aspect, the DC-DC converter (1) further includes: a first input/output terminal (11), a second input/output terminal (12), a third input/output terminal (13), and a fourth input/output terminal (14); a series circuit of a first semiconductor switching element (Q1) and a second semiconductor switching element (Q2); a series circuit of a third semiconductor switching element (Q3) and a fourth semiconductor switching element (Q4); a series circuit of a fifth semiconductor switching element (Q5) and a sixth semiconductor switching element (Q6); a series circuit of a seventh semiconductor switching element (Q7) and an eighth semiconductor switching element (Q8); a first diode (D1), a second diode (D2), a third diode (D3), a fourth diode (D4), a fifth diode (D5), a sixth diode (D6), a seventh diode (D7), and an eighth diode (D8); a first storage circuit (15); and a second storage circuit (16). The series circuit of the first semiconductor switching element (Q1) and the second semiconductor switching element (Q2) is connected between the first input/output terminal (11) and the second input/output terminal (12). The series circuit of the third semiconductor switching element (Q3) and the fourth semiconductor switching element (Q4) is connected between the first input/output terminal (11) and the second input/output terminal (12). The series circuit of the fifth semiconductor switching element (Q5) and the sixth semiconductor switching element (Q6) is connected between the third input/output terminal (13) and the fourth input/output terminal (14). The series circuit of the seventh semiconductor switching element (Q7) and the eighth semiconductor switching element (Q8) is connected between the third input/output terminal (13) and the fourth input/output terminal (14). The first diode (D1), the second diode (D2), the third diode (D3), the fourth diode (D4), the fifth diode (D5), the sixth diode (D6), the seventh diode (D7), and the eighth diode (D8) are connected antiparallel to the first semiconductor switching element (Q1), the second semiconductor switching element (Q2), the third semiconductor switching element (Q3), the fourth semiconductor switching element (Q4), the fifth semiconductor switching element (Q5), the sixth semiconductor switching element (Q6), the seventh semiconductor switching element (Q7), and the eighth semiconductor switching element (Q8), respectively. The first storage circuit (15) is connected between the first input/output terminal (11) and the second input/output terminal (12). The second storage circuit (16) is connected between the third input/output terminal (13) and the fourth input/output terminal (14). In the DC-DC converter (1), the first winding (N1) is connected, via the first capacitor (C1), between a connection node of the first semiconductor switching element (Q1) and the second semiconductor switching element (Q2) and a connection node of the third semiconductor switching element (Q3) and the fourth semiconductor switching element (Q4). In the DC-DC converter (1), the second winding (N2) is connected, via the second capacitor (C2), between a connection node of the fifth semiconductor switching element (Q5) and the sixth semiconductor switching element (Q6) and a connection node of the seventh semiconductor switching element (Q7) and the eighth semiconductor switching element (Q8).

In a power conversion system (100) according to a fourth aspect, which may be implemented in conjunction with the third aspect, each of the first semiconductor switching element (Q1), the second semiconductor switching element (Q2), the third semiconductor switching element (Q3), the fourth semiconductor switching element (Q4), the fifth semiconductor switching element (Q5), the sixth semiconductor switching element (Q6), the seventh semiconductor switching element (Q7), and the eighth semiconductor switching element (Q8) is a MOSFET. The first diode (D1), the second diode (D2), the third diode (D3), the fourth diode (D4), the fifth diode (D5), the sixth diode (D6), the seventh diode (D7), and the eighth diode (D8) are parasitic diodes for the MOSFETs of the first semiconductor switching element (Q1), the second semiconductor switching element (Q2), the third semiconductor switching element (Q3), the fourth semiconductor switching element (Q4), the fifth semiconductor switching element (Q5), the sixth semiconductor switching element (Q6), the seventh semiconductor switching element (Q7), and the eighth semiconductor switching element (Q8), respectively.

The power conversion system (100) according to the fourth aspect does not have to include external diodes as the first diode (D1), the second diode (D2), the third diode (D3), the fourth diode (D4), the fifth diode (D5), the sixth diode (D6), the seventh diode (D7), and the eighth diode (D8). This contributes to cutting down the cost compared to a situation where the first semiconductor switching element (Q1), the second semiconductor switching element (Q2), the third semiconductor switching element (Q3), the fourth semiconductor switching element (Q4), the fifth semiconductor switching element (Q5), the sixth semiconductor switching element (Q6), the seventh semiconductor switching element (Q7), and the eighth semiconductor switching element (Q8) are IGBTs.

In a power conversion system (100) according to a fifth aspect, which may be implemented in conjunction with the third or fourth aspect, the first control mode and the second control mode are respectively a full-bridge control mode and a voltage doubler control mode, or a half-bridge control mode and the voltage doubler control mode, or the half-bridge control mode and the full-bridge control mode. In the full-bridge control mode, the fifth semiconductor switching element (Q5), the sixth semiconductor switching element (Q6), the seventh semiconductor switching element (Q7), and the eighth semiconductor switching element (Q8) are turned OFF to cause the first semiconductor switching element (Q1), the second semiconductor switching element (Q2), the third semiconductor switching element (Q3), and the fourth semiconductor switching element (Q4) to be switched. In the voltage doubler control mode, the fifth semiconductor switching element (Q5), the sixth semiconductor switching element (Q6), and the seventh semiconductor switching element (Q7) are turned OFF, and the eighth semiconductor switching element (Q8) is turned ON to cause the first semiconductor switching element (Q1), the second semiconductor switching element (Q2), the third semiconductor switching element (Q3), and the fourth semiconductor switching element (Q4) to be switched. In the half-bridge control mode, the third semiconductor switching element (Q3) is turned OFF, the fourth semiconductor switching element (Q4) is turned ON, and the fifth semiconductor switching element (Q5), the sixth semiconductor switching element (Q6), the seventh semiconductor switching element (Q7), and the eighth semiconductor switching element (Q8) are turned OFF to cause the first semiconductor switching element (Q1) and the second semiconductor switching element (Q2) to be switched to prevent respective ON-state periods of the first semiconductor switching element (Q1) and the second semiconductor switching element (Q2) from overlapping with each other.

In a power conversion system (100) according to a sixth aspect, which may be implemented in conjunction with any one of the first to fifth aspects, the third drive frequency (f3) is lower than the second drive frequency (f2).

The power conversion system (100) according to the sixth aspect may reduce the chances of generating an overcurrent.

In a power conversion system (100) according to a seventh aspect, which may be implemented in conjunction with any one of the first to fifth aspects, the third drive frequency (f3) is higher than the second drive frequency (f2).

The power conversion system (100) according to the seventh aspect may further reduce the chances of generating an overcurrent.

In a power conversion system (100) according to an eighth aspect, which may be implemented in conjunction with any one of the first to seventh aspects, the control circuit (3) changes, when the first drive frequency (f1) and the second drive frequency (f2) are both equal to or higher than a predetermined frequency, the operation mode directly from the first control mode into the second control mode not via the third control mode during the process.

In a power conversion system (100) according to a ninth aspect, which may be implemented in conjunction with any one of the first to eighth aspects, the control circuit (3) is configured to change the operation mode from the second control mode into the first control mode, when the detector circuit (2) detects a second predetermined change, which is different from a first predetermined change as the predetermined change, in the output voltage (voltage V2), while the control circuit (3) is operating in the second control mode. The detector circuit (2) sets a first threshold value (Vth1) for use to detect the first predetermined change and a second threshold value (Vth2) for use to detect the second predetermined change at mutually different values.

The power conversion system (100) according to the ninth aspect may reduce the chances of causing chattering when switching the first and second control modes.

A power conversion system (100) according to a tenth aspect, which may be implemented in conjunction with any one of the first to ninth aspects, further includes a bidirectional DC-AC converter (4). The bidirectional DC-AC converter (4) is connected to the DC-DC converter (1).

A control method according to an eleventh aspect is a method for controlling a power conversion system (100). The power conversion system (100) includes a DC-DC converter (1) and a detector circuit (2). The DC-DC converter (1) includes a transformer (Tr1), a first capacitor (C1), and a second capacitor (C2). The transformer (Tr1) includes a first winding (N1) and a second winding (N2) and has a first leakage inductance on the first winding (N1) and a second leakage inductance on the second winding (N2). The first capacitor (C1) serves as a resonant capacitor and is connected to the first winding (N1). The second capacitor (C2) serves as a resonant capacitor and is connected to the second winding (N2). The detector circuit (2) detects a change in output voltage (voltage V2) of the DC-DC converter (1). The control method includes controlling the DC-DC converter (1) in a third control mode, in a process of changing, in response of detection of a predetermined change in the output voltage (voltage V2) by the detector circuit (2), an operation mode from a first control mode into a second control mode before starting to control the DC-DC converter (1) in the second control mode. The first control mode is an operation mode in which the DC-DC converter (1) is controlled at a first drive frequency (f1). The second control mode is an operation mode in which the DC-DC converter (1) is controlled at a second drive frequency (f2) higher than the first drive frequency (f1). The third control mode is an operation mode in which the DC-DC converter (1) is controlled at a third drive frequency (f3) higher than the first drive frequency (f1) and different from the second drive frequency (f2).

The control method according to the eleventh aspect may reduce the chances of generating an overcurrent.

### REFERENCE SIGNS LIST

1 DC-DC Converter
11 First Input/Output Terminal
12 Second Input/Output Terminal
13 Third Input/Output Terminal
14 Fourth Input/Output Terminal
15 First Storage Circuit
16 Second Storage Circuit
2 Detector Circuit
3 Control Circuit
4 Bidirectional DC-AC Converter
5 AC Filter
6 Bidirectional Chopper Circuit
C1 First Capacitor
C2 Second Capacitor
C3 Third Capacitor
C4 Fourth Capacitor
D1 First Diode
D2 Second Diode
D3 Third Diode
D4 Fourth Diode
D5 Fifth Diode
D6 Sixth Diode
D7 Seventh Diode
D8 Eighth Diode
f1 First Drive Frequency
f2 Second Drive Frequency
f3 Third Drive Frequency
L1 First Inductor
L2 Second Inductor
Tr1 Transformer
N1 First Winding
N2 Second Winding
Q1 First Semiconductor Switching Element
Q2 Second Semiconductor Switching Element
Q3 Third Semiconductor Switching Element
Q4 Fourth Semiconductor Switching Element
Q5 Fifth Semiconductor Switching Element
Q6 Sixth Semiconductor Switching Element
Q7 Seventh Semiconductor Switching Element
Q8 Eighth Semiconductor Switching Element
V1 Voltage
V2 Voltage
Vt1 First Threshold Value
Vt2 Second Threshold Value

1. A power conversion system comprising:
a DC-DC converter including a transformer, a first capacitor, and a second capacitor, the transformer including a first winding and a second winding and having a first leakage inductance on the first winding and a second leakage inductance on the second winding, the first capacitor serving as a resonant capacitor and being connected to the first winding, the second capacitor serving as a resonant capacitor and being connected to the second winding;
a detector circuit configured to detect a change in output voltage of the DC-DC converter; and
a control circuit configured to control the DC-DC converter,
the control circuit having, as operation modes thereof:
a first control mode in which the control circuit controls the DC-DC converter at a first drive frequency;
a second control mode in which the control circuit controls the DC-DC converter at a second drive frequency, the second drive frequency being higher than the first drive frequency; and
a third control mode in which the control circuit controls the DC-DC converter at a third drive frequency, the third drive frequency being higher than the first drive frequency and different from the second drive frequency,
the control circuit being configured to change the operation mode from the first control mode into the second control mode when the detector circuit detects a predetermined change in the output voltage while the control circuit is operating in the first control mode,
the control circuit being configured to control the DC-DC converter in the third control mode in a process of changing, in response to detection of the predetermined change, the operation mode from the first control mode into the second control mode before starting to control the DC-DC converter in the second control mode.

2. The power conversion system of claim 1, wherein
the predetermined change is a change in the output voltage from a first voltage value into a second voltage value, the second voltage value being different from the first voltage value.

3. The power conversion system of claim 1, wherein
the DC-DC converter further includes:
a first input/output terminal, a second input/output terminal, a third input/output terminal, and a fourth input/output terminal;
a series circuit of a first semiconductor switching element and a second semiconductor switching element, the series circuit of the first semiconductor switching element and the second semiconductor switching element being connected between the first input/output terminal and the second input/output terminal;
a series circuit of a third semiconductor switching element and a fourth semiconductor switching element, the series circuit of the third semiconductor switching element and the fourth semiconductor switching element being connected between the first input/output terminal and the second input/output terminal;
a series circuit of a fifth semiconductor switching element and a sixth semiconductor switching element, the series circuit of the fifth semiconductor switching element and the sixth semiconductor switching element being connected between the third input/output terminal and the fourth input/output terminal;
a series circuit of a seventh semiconductor switching element and an eighth semiconductor switching element, the series circuit of the seventh semiconductor switching element and the eighth semiconductor switching element being connected between the third input/output terminal and the fourth input/output terminal;
a first diode, a second diode, a third diode, a fourth diode, a fifth diode, a sixth diode, a seventh diode, and an eighth diode which are connected antiparallel to the first semiconductor switching element, the second semiconductor switching element, the third semiconductor switching element, the fourth semiconductor switching element, the fifth semiconductor switching element, the sixth semiconductor switching element, the seventh semiconductor switching element, and the eighth semiconductor switching element, respectively;
a first storage circuit connected between the first input/output terminal and the second input/output terminal; and
a second storage circuit connected between the third input/output terminal and the fourth input/output terminal, and
in the DC-DC converter,
the first winding is connected, via the first capacitor, between a connection node of the first semiconductor switching element and the second semiconductor switching element and a connection node of the third semiconductor switching element and the fourth semiconductor switching element, and
the second winding is connected, via the second capacitor, between a connection node of the fifth semiconductor switching element and the sixth semiconductor switching element and a connection node of the seventh semiconductor switching element and the eighth semiconductor switching element.

4. The power conversion system of claim 3, wherein
each of the first semiconductor switching element, the second semiconductor switching element, the third semiconductor switching element, the fourth semiconductor switching element, the fifth semiconductor switching element, the sixth semiconductor switching element, the seventh semiconductor switching element, and the eighth semiconductor switching element is a MOSFET, and
the first diode, the second diode, the third diode, the fourth diode, the fifth diode, the sixth diode, the seventh diode, and the eighth diode are parasitic diodes for the MOSFETs of the first semiconductor switching element, the second semiconductor switching element, the third semiconductor switching element, the fourth semiconductor switching element, the fifth semiconductor switching element, the sixth semiconductor switching element, the seventh semiconductor switching element, and the eighth semiconductor switching element, respectively.

5. The power conversion system of claim 3, wherein
the first control mode and the second control mode are respectively a full-bridge control mode and a voltage doubler control mode, or a half-bridge control mode and the voltage doubler control mode, or the half-bridge control mode and the full-bridge control mode,
in the full-bridge control mode,
the fifth semiconductor switching element, the sixth semiconductor switching element, the seventh semiconductor switching element, and the eighth semiconductor switching element are turned OFF to cause the first semiconductor switching element, the second semiconductor switching element, the third semiconductor switching element, and the fourth semiconductor switching element to be switched,
in the voltage doubler control mode,
the fifth semiconductor switching element, the sixth semiconductor switching element, and the seventh semiconductor switching element are turned OFF, and
the eighth semiconductor switching element is turned ON to cause the first semiconductor switching element, the second semiconductor switching element, the third semiconductor switching element, and the fourth semiconductor switching element to be switched,
in the half-bridge control mode,
the third semiconductor switching element is turned OFF, the fourth semiconductor switching element is turned ON, and
the fifth semiconductor switching element, the sixth semiconductor switching element, the seventh semiconductor switching element, and the eighth semiconductor switching element are turned OFF to cause the first semiconductor switching element and the second semiconductor switching element to be switched to prevent respective ON-state periods of the first semiconductor switching element and the second semiconductor switching element from overlapping with each other.

6. The power conversion system of claim 1, wherein
the third drive frequency is lower than the second drive frequency.

7. The power conversion system of claim 1, wherein
the third drive frequency is higher than the second drive frequency.

8. The power conversion system of claim 1, wherein
the control circuit is configured to, when the first drive frequency and the second drive frequency are both equal to or higher than a predetermined frequency, change the operation mode directly from the first control mode into the second control mode not via the third control mode during the process.

9. The power conversion system of claim 1, wherein
the control circuit is configured to change the operation mode from the second control mode into the first control mode, when the detector circuit detects a second predetermined change, which is different from a first predetermined change as the predetermined change, in the output voltage, while the control circuit is operating in the second control mode, and
the detector circuit is configured to set a first threshold value for use to detect the first predetermined change and a second threshold value for use to detect the second predetermined change at mutually different values.

10. The power conversion system of claim 1, further comprising a bidirectional DC-AC converter connected to the DC-DC converter.

11. A method for controlling a power conversion system, the power conversion system including:
a DC-DC converter including a transformer, a first capacitor, and a second capacitor, the transformer including a first winding and a second winding and having a first leakage inductance on the first winding and a second leakage inductance on the second winding, the first capacitor serving as a resonant capacitor and being connected to the first winding, the second capacitor serving as a resonant capacitor and being connected to the second winding; and
a detector circuit configured to detect a change in output voltage of the DC-DC converter,
the method comprising controlling the DC-DC converter in a third control mode, in a process of changing, in response of detection of a predetermined change in the output voltage by the detector circuit, an operation mode from a first control mode into a second control mode before starting to control the DC-DC converter in the second control mode,
the first control mode being an operation mode in which the DC-DC converter is controlled at a first drive frequency,
the second control mode being an operation mode in which the DC-DC converter is controlled at a second drive frequency, the second drive frequency being higher than the first drive frequency,
the third control mode being an operation mode in which the DC-DC converter is controlled at a third drive frequency, the third drive frequency being higher than the first drive frequency and different from the second drive frequency.
